(19) United States
(12) Patent Application Publication
(10) Pub. No.: US 2005/0044292 A1
(43) Pub. Date: Feb. 24, 2005

(54) Method and apparatus to retain system control when a buffer overflow attack occurs

(76) Inventor: Francis X. McKeen, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/644,399

(22) Filed: Aug. 19, 2003

(51) Int. Cl. G06F 3/00

(52) U.S. Cl. 710/51

(57) ABSTRACT

In one embodiment, a method is provided. The method comprises encountering a function call instruction that calls a called function during program execution; saving a return address in a first stack and in a second stack, the return address containing an instruction to be executed after execution of the called function; executing the called function; and determining if the return address stored in the first stack matches the return address stored in the second stack.

### FIELD OF THE INVENTION

This invention relates to computer system security. In particular, the invention relates to buffer overflow attacks that are used to take control of a computer system.

### BACKGROUND

Many computer systems today are vulnerable to attack using a technique known as a buffer overflow attack and more colloquially as “stack smashing.”

A stack is an area of memory that is dynamically assigned to a program by an operating system and comprises a number of contiguous memory locations to which data/variables required by the program may be written.

Programs today are written in a form in which reusable portions of code are identified with a function name that may be called from any location within the program by a function call instruction that identifies the function being called. Generally, when a function is called (hereinafter, the “called function”), the processor saves the return address at which program execution is to resume after execution of the called function on the stack. Thereafter, the operating system saves many of the variables/data required by the called function on the stack. For this purpose, the operating system allocates a stack frame or buffer within the stack to hold the data/variables.

FIG. 1 shows an example of a stack 100 wherein a buffer 104 comprising only four memory locations has been allocated. If, in this case, the data being written to the buffer 104 requires more than four memory locations, then the buffer 104 will be overwritten. This results in a return address 102 being overwritten.

In the case of a buffer overflow attack, a malicious programmer can take control of a computer system by writing data 202 (see FIG. 2) into a variable called buffer 104 to cause the buffer 104 to overflow as a result of which the return address 102 is overwritten with a pointer 200 to virus code. Thus, upon completion of the called function, the program will resume execution at the address indicated by the pointer 200 to the virus code, resulting in virus code 204 being executed.

### BRIEF DESCRIPTION OF THE DRAWINGS

FIG. 1 shows a block diagram of a stack for a program before buffer overflow;

FIG. 2 shows a block diagram for a stack for the program after buffer overflow;

FIG. 3 shows a block diagram of hardware in accordance with one embodiment of the invention;

FIG. 4 shows a flowchart of operations from by the hardware of FIG. 3, in accordance with one embodiment; and

FIG. 5 shows a block diagram of dual stacks in accordance with one embodiment of the invention.

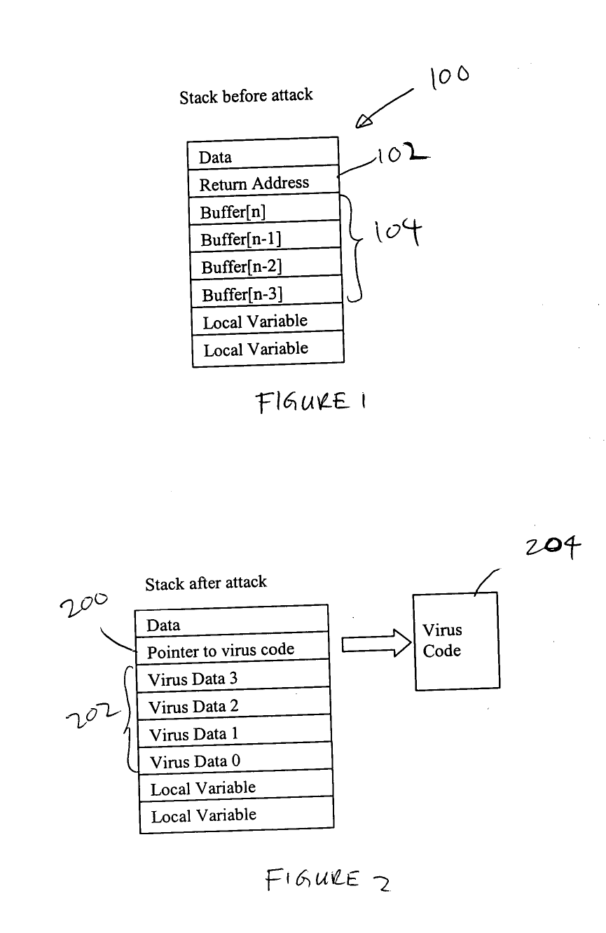

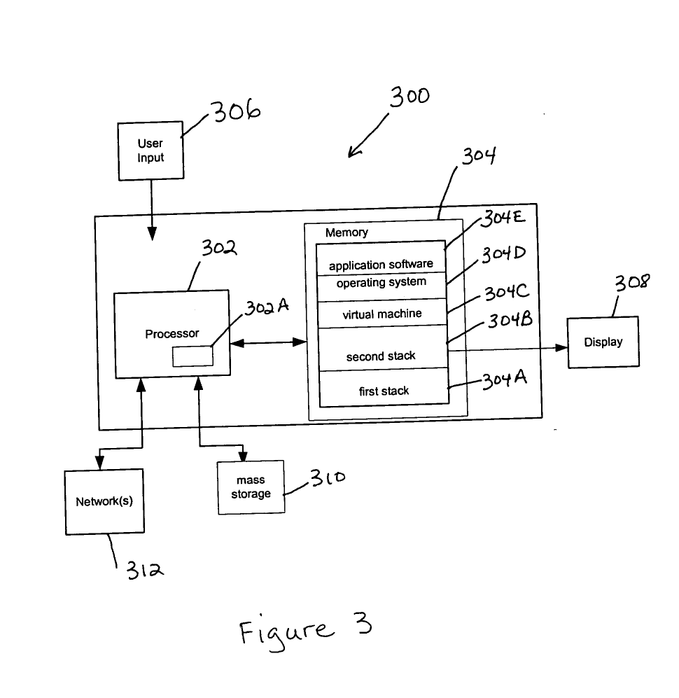

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

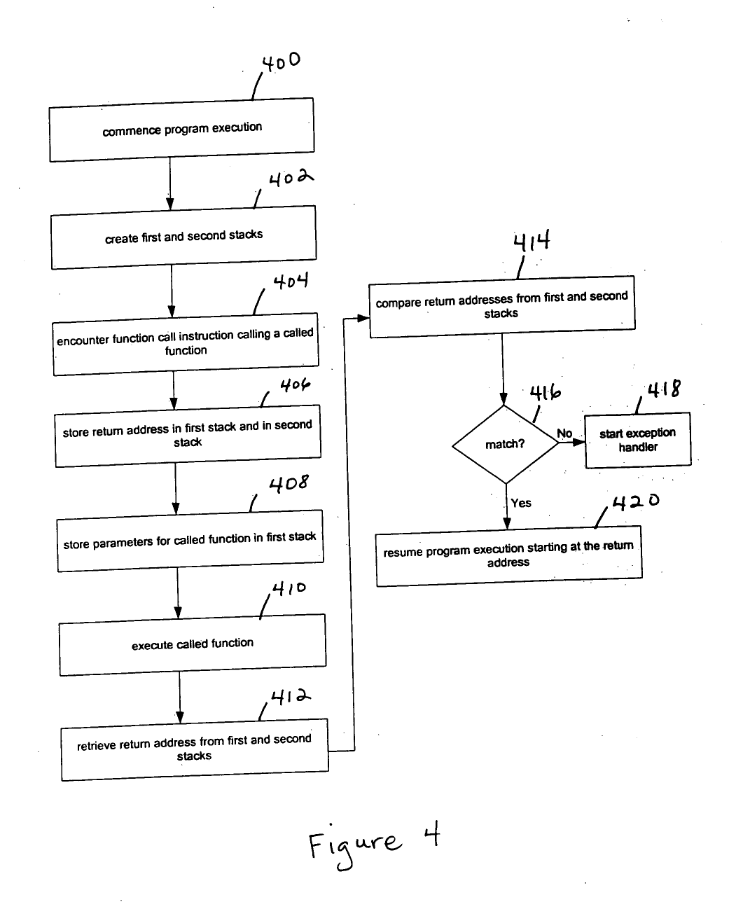

Referring to FIG. 3 of the drawings, reference numeral 300 generally indicates hardware representative of a system in accordance with embodiments of the invention. The hardware 300 typically includes at least one processor 302 coupled to a memory 304. The processor 302 includes a read-only memory (ROM) 302A. The processor 302 may represent one or more processors (e.g. microprocessors), and the memory 304 may represent random access memory (RAM) devices comprising a main storage of the hardware 300, as well as any supplemental levels of memory e.g., cache memories, non-volatile or back-up memories (e.g. programmable or flash memories), read-only memories, etc. In addition, the memory 304 may be considered to include memory storage physically located elsewhere in the hardware 300, e.g. cache memory in the processor 302, as well as any storage capacity used as a virtual memory, e.g., as stored on a mass storage device 310. In one embodiment, the memory 304 can conveniently be thought of as having areas 304A-304E. The areas 304A and 304B are areas of the memory 304 corresponding to where a first stack and a second stack, respectively, are stored. The area 304C is an area of the memory 304 that contains an implementation of a virtual machine. The area 304D contains an operating system for the hardware 300, and the area 304E contains application software.

The hardware 300 also typically receives a number of inputs and outputs for communicating information externally. For interface with a user or operator, the hardware 300 may include one or more user input devices 306 (e.g., a keyboard, a stylus and digitizer, etc.) and a display 308 (e.g., a liquid crystal display (LCD) panel).

For additional storage, the hardware 300 may also include one or more mass storage devices 310, e.g., a disk drive such as a Compact Flash device. Furthermore, the hardware 300 may include an interface with one or more networks 312 (e.g., a local area network (LAN), a wide area network (WAN), a wireless network, and/or the Internet among others) to permit the communication of information with other computers coupled to the networks. It should be appreciated that the hardware 300 typically includes suitable analog and/or digital interfaces between the processor 302 and each of the components 304, 306, 308 and 312 as is well known in the art.

The hardware 300 operates under the control of the operating system 304D that executes various computer software applications, components, programs, objects, modules, etc.

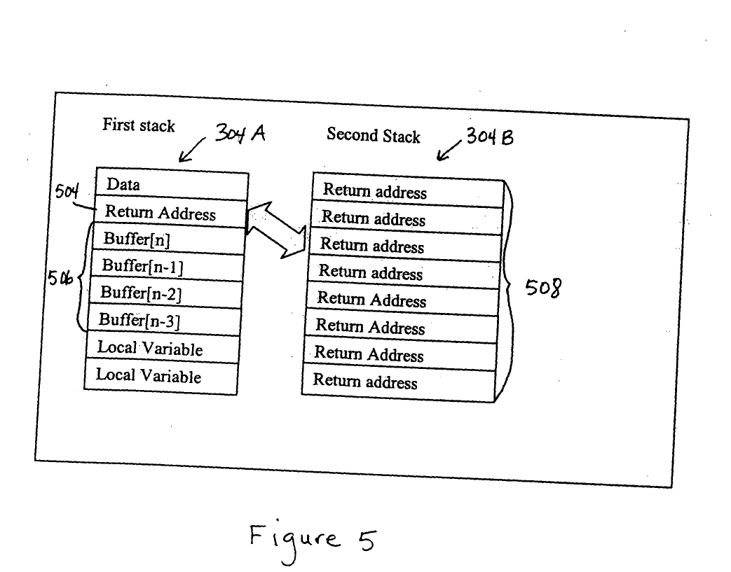

Referring now to FIG. 4 of the drawings, operations performed by the hardware 300 of FIG. 3, in accordance with one embodiment are shown. At 400, the hardware 300 commences execution of a software program. At 402, the operating system 304D creates the first stack 304A, and the second stack 304B. At 404, the processor 302 encounters a function call instruction calling a called function. At block 406, the processor 302 stores the return address at which the program is to resume execution after execution of the called function in the first stack 304A, as well as in the second stack 304B. Thus, there are two copies of the return address, one copy in the first stack 304A, and the other copy in the second stack 304B. At block 408, parameters or data required for proper execution of the called function are also stored in the first stack 304A. Embodiments of first stack 304A and the second stack 304B as shown in FIG. 5 of the drawings. As will be seen, the first stack 304A contains a return address 504, as well as a buffer 506 which is used to store parameters required for the called function. The second stack 304B contains a return addresses 508 associated with various function calls.

Referring again to FIG. 4 of the drawings, at block 410, the hardware 300 executes the called function. At block 412, the return addresses are retrieved by the processor from the second stack 304B and the first stack 304A. Thereafter, at 414, the processor 302 compares the return addresses in the first and second stacks 304A, 304B. If, at block 416, the return addresses match then the block 420 is executed, wherein program execution is resumed starting at the return address. If, however, at 416 it is determined that the return addresses from the first and second stacks do not match, then block 418 executes and program flow is transferred to an exception handler (not shown).

It is to be understood that in the hardware 300 the virtual machine implementation 304C is optional. However, in cases where the hardware 300 does include the virtual machine implementation 304C, then the operations shown in FIG. 4 of the drawings may be performed by the virtual machine implementation which is under control of a virtual machine operating system. The virtual machine is responsible for storing the second stack 304B in the memory 304. Upon detection of a mismatch between the return addresses from the first and second stacks, the virtual machine operating system is exited and control is returned to the operating system 304D, in one embodiment, when program flow is transferred to the exception handler at 418.

The exception handler of the present invention may be implemented in hardware or in software. In one embodiment, the exception handler may terminate execution of the program entirely and report the occurrence of the buffer overflow condition to the operating system or to a user. In one case, the exception handler may be configured to use the return address from the second stack 304B as the address at which program flow is to resume. There may be cases in which the exception handler may decide that it is safe to use the return address from the first stack.

The operating system 304D includes memory management logic to create the first and second stacks in memory. The ROM 302A includes function call logic which (a) saves the return addresses to the first and second stacks, respectively, and (b) saves the parameters required by the called function on the first stack, and the buffer overflow control logic which determines whether to resume program flow using return address from the first stack, or to start the exception handler as described. The function call logic is responsible for managing a stack pointer for the second stack.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of signal bearing media used to actually effect the distribution. Examples of signal bearing media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Although the present invention has been described with reference to specific exemplary embodiments, it will be evident that the various modification and changes can be made to these embodiments without departing from the broader spirit of the invention as set forth in the claims. Accordingly, the specification and drawings are to be regarded in an illustrative sense rather than in a restrictive sense.

1. A method, comprising:
encountering a function call instruction that calls a called function during program execution;
saving a return address in a first stack and in a second stack, the return address containing an instruction to be executed after execution of the called function;
executing the called function; and
determining if the return address stored in the first stack matches the return address stored in the second stack.

2. The method of claim 1, further comprising generating an exception if the return addresses do not match.

3. The method of claim 2, further comprising executing exception handling code if an exception was generated.

4. The method of claim 3, wherein the exception handling code determines what value to pass to a program pointer based on the return addresses retrieved from the first and second stack.

5. The method of claim 3, wherein the exception handling code terminates execution of the program.

6. A method, comprising:
processing instructions within a virtual machine;
saving a return address in a first stack and in a second stack, the return address being an address at which program execution is to resume after execution of a called function;
comparing the return addresses saved in the first and second stack upon execution of the called function; and
exiting the virtual machine if the return addresses do not match.

7. The method of claim 6, further comprising passing control to an exception handler.

8. The method of claim 7, wherein the exception handler determines if the return address from the first stack or the return address from the second stack is to be used as a value for an instruction pointer.

9. A method, comprising:
creating first and second stacks for a program during execution of the program;
encountering a function call to a called function;
storing data for the called function and a return address in the first stack;
storing the return address in the second stack; and
passing control of the program to an exception handler if the return address stored in the first stack does not match the return address stored in the second stack upon execution of the called function.

10. The method of claim 9, wherein the exception handler determines if the return address from the first stack, or the return address from the second stack is to be used as a value for an instruction pointer.

11. A processor, comprising:
memory management logic to allocate first and second memory locations corresponding to first and second stacks, respectively, when a function call instruction calls to a called function is encountered during program execution;
function call logic to write a return address to a memory location from the first memory locations and to a memory location from the second memory locations, the return address being an address at which program flow is to resume after execution of the called function; and
buffer overflow control logic to determine if the return address retrieved from the first stack matches the return address retrieved from the second stack, upon execution of the called function.

12. The processor of claim 11, wherein the function call logic and the buffer overflow control logic comprises microcode stored within the processor.

13. A system, comprising:
a memory; and
a processor coupled to the memory, the processor comprising memory management logic to allocate first and second memory locations corresponding to first and second stacks, respectively, when a function call instruction that calls a called function is encountered during program execution;
function call logic to write a return address to a memory location from the first memory locations and to a memory location from the second memory locations, the return address being an address at which program flow is to resume after execution of the called function; and
buffer overflow control logic to determine if the return address retrieved from the first stack matches the return address retrieved from the second stack, upon execution of the called function.

14. The system of claim 13, wherein the memory management logic, the function call logic, and the buffer overflow control logic comprise microcode stored within the processor.

15. A computer readable medium having stored thereon a sequence of instructions which when executed by a processor, cause the processor to perform a method comprising:
encountering a function call instruction that calls a called function during program execution;
saving a return address in a first stack and in a second stack, the return address containing an instruction to be executed after execution of the called function;
executing the called function; and
determining if the return address stored in the first stack matches the return address stored in the second stack.

16. The computer readable medium of claim 15, wherein the method further comprises generating an exception if the return addresses do not match.

17. A computer readable medium having stored thereon a sequence of instructions which when executed by a processor, cause the processor to perform a method comprising:
processing instructions within a virtual machine;
saving a return address in a first stack and in a second stack, the return address being an address at which program execution is to resume after execution of a called function;
comparing the return addresses saved in the first and second stack upon execution of the called function; and
exiting the virtual machine if the return addresses do not match.

18. The computer readable medium of claim 17, wherein the method further comprises passing control to an exception handler.

19. A computer readable medium having stored thereon a sequence of instructions which when executed by a processor, cause the processor to perform a method comprising:
creating first and second stacks for a program during execution of the program;
encountering a function call to a called function;
storing data for the called function and a return address in the first stack;
storing the return address in the second stack; and
passing control of the program to an exception handler if the return address stored in the first stack does not match the return address stored in the second stack upon execution of the called function.

20. The computer readable medium of claim 19, wherein the exception handler determines if the return address from the first stack and the return address from the second stack is to be used as a value for an instruction pointer.
